(19) United States
(12) Patent Application Publication
(10) Pub. No.: US 2003/0177046 A1
(43) Pub. Date: Sep. 18, 2003

(54) Method and system for reusing components

(76) Inventor: John Socha-Leialoha, Bellevue, WA (US)

Correspondence Address: PERKINS COIE LLP, PATENT-SEA, P.O. BOX 1247, SEATTLE, WA, 98111-1247, US

(21) Appl. No.: 10/308,880

(22) Filed: Dec. 3, 2002

Related U.S. Application Data
(60) Provisional application No. 60/336,826, filed on Dec. 3, 2001.

(51) Int. Cl. G06F 17/60

(52) U.S. Cl. 705/7

(57) ABSTRACT

Methods and systems for executing workflow tasks. The workflow system dynamically generates definitions of workflow tasks (e.g., business applications) when a request to perform a task is received. Each definition identifies components of the workflow task and identifies a data input rule and a data output rule for each component. The workflow system executes a workflow task in accordance with its definition. To execute a workflow task, the workflow system executes each of its components. The workflow system maintains a data area for an executing workflow task containing data that is available for use by the components and available to be updated by the components.

### CROSS REFERENCE TO RELATED APPLICATIONS

This application claims the benefit of U.S. Provisional Patent Application No. 60/336,826 filed Dec. 3, 2001, entitled, “METHOD AND SYSTEM FOR REUSING COMPONENTS,” which is hereby incorporated by reference in its entirety.

### BACKGROUND

Business server application models typically provide tools and services that allow a company to create executable applications for controlling business processes and for exchanging data with other companies. Such business application server models may allow a programmer to specify a sequence of actions that describe a business process, such as receiving a customer purchase order, generating a supplier purchase order from a customer purchase order, and submitting the supplier purchase order to the supplier. When a customer purchase order is received, the appropriate business application is selected and executed. The business application is typically selected based on the supplier who will supply the ordered product. A programmer would typically need to specify a different business application for each combination of customer and supplier purchase orders. When a new type of customer purchase order is to be supported, a programmer would typically create a copy of an existing business application that supports a similar type customer purchase order and customize that copy for the new type of customer purchase order. The programmer may need to create a copy for each possible supplier. In general, a different business application is needed to process each different type of data that is received or sent by a company.

The generating of a different business application for each type of data has several disadvantages. First, it is time-consuming, expensive, and error prone to generate a business application for each different type of data. Second, when an action that is shared by many business applications is modified, each of these business applications may need to be correspondingly modified. It would be desirable to have a technique for generating business applications that would minimize these disadvantages.

The technology of the detailed description section is described with reference to the Extensible Markup Language (“XML”) and to XML style sheets. XML is a set of rules for defining semantic tags (or elements) of documents. These tags identify different parts of the documents. For example, a document describing an order to be placed by a customer may include an “order” tag, a “purchase order number” tag, “stock keeping unit” (“SKU”) tags, and so on. Table 1 illustrates a sample XML document.

TABLE 1

| | |
|---|---|
| 1. | <order> |

| | |
|---|---|
| 2. | <p number>12321<</po number> |
| 3. | <item> |

| | |
|---|---|
| 4. | <sku>55551</sku> |
| 5. | <quantity>2</quantity> |

| | |
|---|---|
| 6. | </item> |
| 7. | <item> |

| | |
|---|---|
| 8. | <sku>55552</sku> |
| 9. | <quantity>1</quantity> |

| | |
|---|---|
| 10. | </item> |

| | |
|---|---|
| 11. | </order> |

The “order” tags (i.e., <order> and </order>) of lines 1 and 11 delimit and identify the information of the order, the “po number” tags of line 2 delimit and identify a purchase order number (i.e., “12321”), and the “item” tags of lines 3 and 6 and lines 7 and 10 delimit and identify the information of each item being ordered.

The Extensible Style Sheet Language (“XSL”) is a style sheet language designed specifically for use with XML documents. XSL specifies a formatting language and a transformation language. XSL documents are themselves well-formed XML documents. The XSL formatting language describes how content should be rendered when presented to a user. XSL documents contain a series of rules that are to be applied to particular patterns of XML elements. When an XSL document is applied to an XML document, the patterns of the XSL document are identified in the XML document and the formatting information associated with a pattern in the XSL document is applied to the matching pattern in the XML document. Table 2 contains an example of an XSL document that can be applied to the XML document of Table 1.

TABLE 2

| | |
|---|---|
| 1. | <xsl:stylesheet version=“1.0”mlns:xsl=“http://www.w3.org/ |

1999/XSL/Transform”>
2.

| | |
|---|---|
| 3. | <xsl:template match=“/*”> |

| | |
|---|---|
| 4. | <table border=“1”> |

| | |
|---|---|
| 5. | <xsl:apply-templates/> |

| | |
|---|---|
| 6. | </table> |

| | |
|---|---|
| 7. | </xsl:template> |
| 8. | |
| 9. | <xsl template match=“/*/po number”> |

| | |
|---|---|
| 10. | </tr> |

| | |
|---|---|
| 11. | <td colspan=“3”class“Subhead”> |

| | |
|---|---|
| 12. | <xsl:value-of select=“local-name( )”/> |
| 13. | :<xsl:apply-templates/> |

| | |
|---|---|
| 14. | </td> |

| | |
|---|---|
| 15. | </tr> |

| | |
|---|---|
| 16. | </xsl:template> |
| 17. | |
| 18. | <xsl:template match=“/*/item”> |
| 19. | <tr> |

| | |
|---|---|
| 20. | <td class=“Subhead”> |

| | |
|---|---|
| 21. | <xsl:value-of select=“local-name( )”/> |

| | |
|---|---|
| 22. | </td> |
| 23. | <xsl:apply-templates/> |

| | |
|---|---|
| 24. | </tr> |
| 25. | </xsl:template> |
| 26. | |
| 27. | <xsl:template match=“/*/*/*”> |

| | |
|---|---|
| 28. | <td class“Body”> |

| | |
|---|---|
| 29. | <xsl:value-of select=“local”name( )”/> |
| 30. | :<xsl:apply-templates/> |

| | |
|---|---|
| 31. | </td> |

| | |
|---|---|
| 32. | </xsl template> |

| | |
|---|---|
| 33. | </xsl:stylesheet> |

The transformation language of XSL provides elements that define rules for how one XML document is transformed into another XML document. XSL documents include templates or patterns that are to be matched in an XML document. When a template is matched, the XSL document specifies the output for the new document. That output may be a combination of information from the XML document or information specified in the XSL document. XML, and XSL are described in the book entitled “XML Bible,” written by Elliotte Rusty Harord, and published by IDG Books Worldwide, Inc. in 1999 and which is hereby incorporated by reference.

### BRIEF DESCRIPTION OF THE DRAWINGS

FIG. 1 is a block diagram illustrating a workflow task definition in one embodiment.

FIG. 2 is a flow diagram illustrating overall processing of a function of the workflow system that executes workflow task in one embodiment.

FIG. 3 is a flow diagram illustrating overall processing of a function that creates a workflow task in one embodiment.

FIG. 4 is a block diagram illustrating the architecture of the workflow system in one embodiment.

FIG. 5 is a flow diagram illustrating processing of the process workflow function in one embodiment.

FIG. 6 is a flow diagram illustrating processing of the create workflow task function in one embodiment.

FIG. 7 is a flow diagram illustrating processing of the add context function in one embodiment.

FIG. 8 is a flow diagram illustrating processing of the initialize steps function in one embodiment.

FIG. 9 is a flow diagram illustrating processing of the initialize data function in one embodiment.

FIG. 10 is a flow diagram illustrating processing of the initialize data section function in one embodiment.

FIG. 11 is a flow diagram illustrating processing of the do next step function in one embodiment.

FIG. 12 is a flow diagram illustrating processing of the run step function in one embodiment.

FIG. 13 is a flow diagram illustrating processing of the initialize step data function in one embodiment.

FIG. 14 is a flow diagram illustrating processing of the copy from selection function in one embodiment.

FIG. 15 is a flow diagram illustrating processing of the save results function in one embodiment.

FIG. 16 is a flow diagram illustrating processing of the update data function in one embodiment.

FIG. 17 is a flow diagram illustrating processing of the copy to selection function in one embodiment.

### DETAILED DESCRIPTION

Methods and systems for executing workflow tasks are provided. In one embodiment, the workflow system dynamically generates definitions (or instances) of workflow tasks (e.g., business applications) when a request to perform a task is received. Each definition identifies components of the workflow task and optionally identifies a data input rule and a data output rule for each component. The workflow system executes a workflow task in accordance with its definition. To execute a workflow task, the workflow system executes each of its components. The workflow system maintains a data area for an executing workflow task containing data that is available for use by each component and available to be updated by each component. Prior to executing a component, the workflow system applies the data input rule for the component to data of the workflow task to generate input data for the component. The workflow system then invokes the component passing the generated input data. Upon completing its execution, the component returns output data. The workflow system applies the data output rule for the component to the output data to generate updated data for the workflow task. The updated data is then available as input data to subsequently invoked components of the workflow task. In one embodiment, the definition of a workflow task is provided as an XML document, and the data input and output rules are provided in an XSL format. Because the data input rules and the data output rules can be customized to a workflow task, a component can be shared or reused by multiple workflow tasks. The data input rules and the data output rules transform the data of the workflow task to and from a format needed by a reused component.

The workflow system generates a definition of (or instantiates) a workflow task based on a workflow plan and a workflow message. The workflow system maintains a collection of workflow plans that each specify an optional data initialization rule and a sequence of components along with an optional data input rule and an optional data output rule for each component. Each workflow plan has a task type (e.g., create purchase order). A workflow message identifies a task type and contains data for the task (e.g., identification of items to be purchased). In one embodiment, the workflow plans and workflow messages are XML documents. When the workflow system receives a workflow message, it identifies a workflow plan based on the task type in the workflow message. The workflow system then applies the data initialization rule of the workflow plan to generate the initial data for the workflow task. The data initialization rule may be alternatively applied when the generated workflow task is executed. The data initialization rule may copy data from the workflow message to a data area for the workflow task. The workflow system adds an indication of the components (and their data input and output rules) of the workflow plan to the workflow task. The workflow system then executes the workflow task.

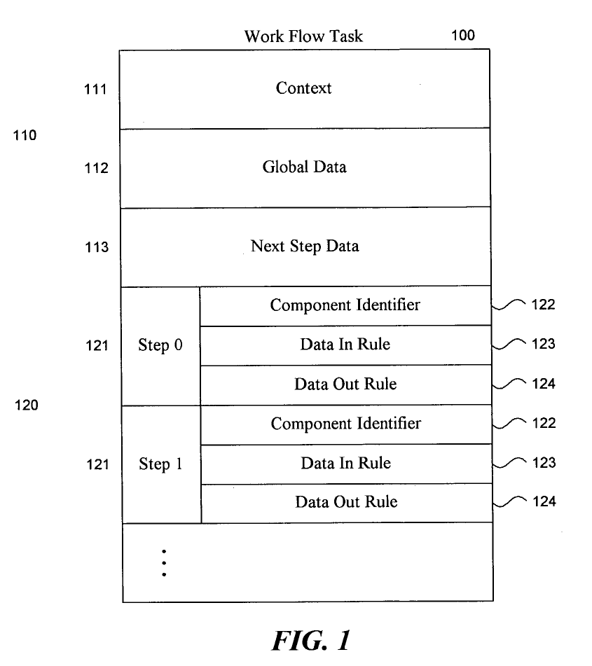

FIG. 1 is a block diagram illustrating a workflow task definition in one embodiment. The workflow task definition 100 includes a data area 110 and a steps area 120. The data area contains context data 111, global data 112, and next step data 113 initialized by the data initialization rule of the workflow message. The steps area includes a step definition 121 for each step of the workflow task. A step specifies a component and its optional data input and output rules. A step definition includes a component identifier 122, a data input rule 123, and a data output rule 124. In one embodiment, the workflow system executes a workflow task by sequentially performing each step of the workflow task. The workflow system performs a step by instantiating (if not already instantiated) the identified component, applying its data input rule to the workflow task data to generate input data, invoking the instantiated component passing the generated input data, receiving output data generated by the component, and applying the data output rule of the component to update the workflow task data. The context data may include information of the workflow message that specifies the data sources (e.g., product database) to be accessed by the workflow task. In one embodiment, the context data may be static data used by, but not modified by, the components of the workflow task. The global data is data shared by the components of the workflow tasks and may be used to pass data from one component to the next. The next step data is data that is available only to be used by and updated by the next step that is to be performed. The workflow task system may clear the next step data before it is updated by the data output rule of a component. In one embodiment, the data of the data area is stored as an XML document.

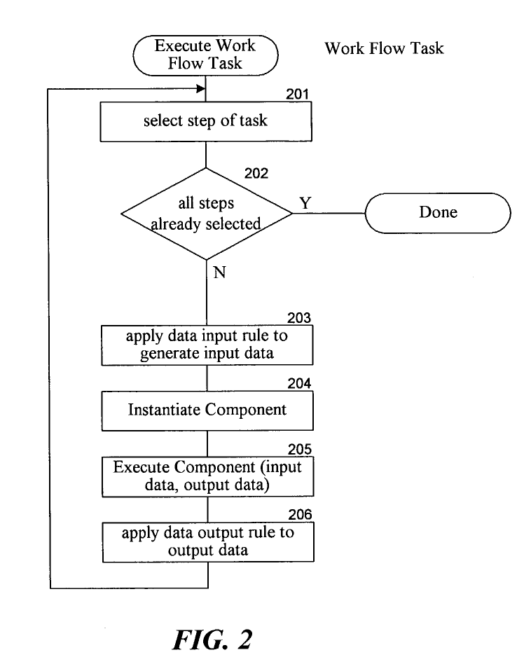

FIG. 2 is a flow diagram illustrating overall processing of a function of the workflow system that executes a workflow task in one embodiment. The function is passed a workflow task definition that has been dynamically generated in response to receiving a workflow message. In block 201, the function selects the next step of the workflow task. In decision block 202, if all the steps of the workflow task have already been selected, then the execution of the workflow task is complete and the function completes, else the function continues at block 203. In block 203, the function applies the data input rule of the selected step to the workflow task data to generate the input data for the component. In one embodiment, the data input and data output rules are specified as XSL transforms. The data input rule may access the context, global, and next step data to generate the input data. In block 204, the function instantiates the component of the selected step. In one embodiment, if the same component is specified by multiple steps of a workflow task, then the component need only be instantiated once. In block 205, the function invokes a method of the instantiated component passing the input data and receiving the output data in return. The input data and output data may be specified in an XML format. Thus, each component is invoked passing the input data in XML format and returns the output data in XML format. Each component may provide a standard interface defined by and invoked by the workflow system. In block 206, the function applies the data output rule for the selected step to the output data to update the workflow task data. The data output rule may update the global and next step data. The function then loops to block 201 to select the next step.

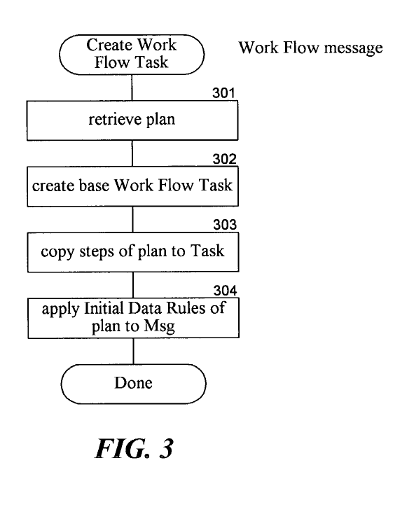

FIG. 3 is a flow diagram illustrating overall processing of a function that creates a workflow task in one embodiment. This function is passed a workflow message and returns a workflow task to process that message. In block 301, the function retrieves the workflow plan corresponding to the workflow message. In one embodiment, the workflow message may contain a workflow plan identifier. In block 302, the function creates a base workflow task. The base workflow task may contain various standard XML elements of the workflow task, such as a “workflow task” tag. In block 303, the function copies the steps of the retrieved workflow plan to the workflow task. In block 304, the function applies the data initialization rule of the workflow plan to the workflow message to generate the initial workflow task data. The initial workflow task data is stored in the data area of the workflow task. The function then completes.

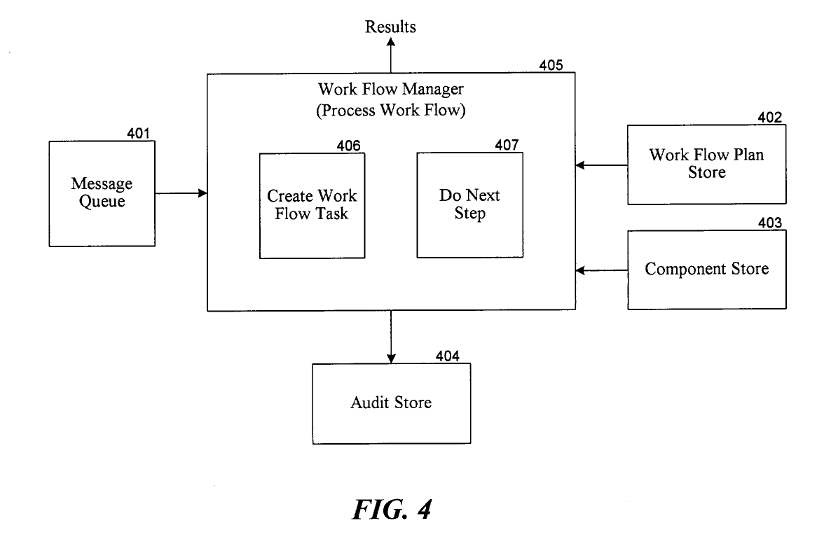

FIG. 4 is a block diagram illustrating the architecture of the workflow system in one embodiment. The workflow system may include a workflow message queue 401, a workflow plan store 402, a component store 403, an audit store 404, and a workflow manager 405. Messages to be processed by the workflow system are stored in the workflow message queue. The workflow message system creates an instance of the workflow manager for each workflow message that is to be processed. The workflow plan store contains an entry for each workflow plan that has been defined. The workflow manager includes a create workflow task function 406 and a do next step function 407. The create workflow task function retrieves the appropriate workflow plan from the workflow plan store to create a workflow task based on a workflow message. The component store contains the code for the various components that are specified by the workflow plans. The workflow manager invokes the do next step component to perform each step of a workflow task. The do next step function retrieves the components to be instantiated from the component store. The workflow manager may create an audit trail of the input data and output data of each step of the workflow task. In addition to providing the output data, an executing component may access data sources and send and receive messages to effect the performance of a business (or other type of) application. A component in general can perform any processing designated by a programmer. The workflow system may execute on a computer that includes a central processing unit, memory, input devices (e.g., keyboard and pointing devices), output devices (e.g., display devices), and storage devices (e.g., disk drives). The memory and storage devices are computer-readable media that may contain instructions and data structures (e.g., workflow plans) of the workflow system. In addition, the data structures may be stored or transmitted via a data transmission medium, such as a signal on a communications link. In addition, the computer may provide various communications links through which an executing workflow task can communicate to other computers.

Tables 3-5 illustrates the overall structure of workflow messages, plans, and tasks. Table 3 illustrates an XML schema of a workflow message for creating a workflow task. Lines 1 and 11 indicate that the message includes a create workflow element. As indicated by line 2, the create workflow element includes a plan identifier element that specifies the identifier of the plan to be used when creating the workflow task. As indicated by lines 3-10, the message also includes a data element. The data element contains the data defining the message. As indicated by lines 4-8, the data element may include a context element that contains context data for the workflow task. In this example, the context data may include a document type, a source identifier, and a destination identifier. The document type specifies the type of document to be processed by the workflow task. The source identifier identifies the source of the message (e.g., customer). The destination identifier identifies the destination for the message (e.g., supplier). As indicated by line 9, the message may also include various other elements that define the business data for the message. For example, these elements may include the order element of Table 1.

TABLE 3
Workflow Message Schema

| | |
|---|---|
| 1. | <Create WorkFlow> |

| | |
|---|---|
| 2. | <PlanID>value</PlanID> |
| 3. | <Data> |

| | |
|---|---|
| 4. | <wrk:Context> |

| | |
|---|---|
| 5. | <DocType>value</DocType> |
| 6. | <SourceID>value</SourceID> |
| 7. | <DestID>value</DestID> |

| | |
|---|---|
| 8. | </wrk:Context> |
| 9. | elements |

| | |
|---|---|
| 10. | </Data> |

| | |
|---|---|
| 11. | </CreateWorkflow> |

Table 4 illustrates a schema of workflow plan in one embodiment. As indicated by lines 1 and 28, a workflow plan includes a workflow plan element with a name attribute. The name attribute may correspond to the plan identifier (e.g., plan type). As indicated by lines 2-9, a workflow plan includes an initial data element containing the data initialization rule of the workflow plan. As indicated by lines 3-8, the initial data element may include a global element and the next step element. These elements define rules for transforming the data of the workflow message into the initial data for a workflow task. In one embodiment, these rules are XSL transforms that are applied to the workflow message. As indicated by lines 10-27, the steps element defines the various steps of the workflow plan. As indicated by lines 11-25, a step may include a program identifier element, a save object identifier element, an object identifier element, a method element, a data in element, and a data out element. The step element may also include a select attribute. The value of the select attribute indicates a condition that is to be evaluated to determine whether a step should be performed during execution of the workflow task. For example, a step that transmits a purchase order to a supplier may only be performed when the previous steps successfully created the purchase order. The program identifier element provides the identifier of the component to be executed. The save object identifier element indicates that the instantiated component should be saved using the specified object identifier for subsequent execution by another step of the workflow task. The object identifier element indicates the identifier of a component that has already been instantiated and assigned the specified object identifier by another step of the workflow task. A step of a workflow plan thus either has the program identifier element or the object identifier element. The presence of the save object identifier element indicates that the object or instantiated component should be saved for subsequent execution by another step of the workflow task. The method element specifies a method of the component that is to be invoked. The data in element defines the data input rule for the step. As indicated by line 18, the data input rule may include an XSL transform or other elements. The other elements may specify constant data to be passed to the component. The attributes of the data in element may indicate to use all the global data as the input data, all the next step data, or both as the input data. If one of these attributes is specified, then the element at line 18 may be ignored or alternatively may also be applied. The data out element specifies an XSL transform or other elements for updating the workflow task data. The global and next step elements of the data out element specify whether all the data of the corresponding element returned by the component should be saved to the global or next step data areas.

TABLE 4
Workflow Plan Schema

| | |
|---|---|
| 1. | <WorkflowPlan name=“value”> |

| | |
|---|---|
| 2. | <InitData default=“value”> |

| | |
|---|---|
| 3. | <Global all=“value”> |

| | |
|---|---|
| 4. | elements |

| | |
|---|---|
| 5. | </Global> |
| 6. | <NextStep all=“value”> |

| | |
|---|---|
| 7. | elements |

| | |
|---|---|
| 8. | </NextStep> |

| | |
|---|---|
| 9. | </InitData |
| 10. | <Steps> |

| | |
|---|---|
| 11. | <Step select=“value”> |

| | |
|---|---|
| 12. | <ProgID>progID</ProgID> |
| 13. | <SaveObjectID>objectID</SaveObjectID> |
| 14. | <ObjectID>objectID</ObjectID> |
| 15. | <Method>method</Method> |
| 16. | <DataIn copy-global=“value” |

| | |
|---|---|
| 17. | copy-nextstep=“value”> |

| | |
|---|---|
| 18. | element |

| | |
|---|---|
| 19. | </DataIn> |
| 20. | <DataOut> |

| | |
|---|---|
| 21. | <Global save-all=“value”> |
| 22. | <NextStep save-all=“value”> |
| 23. | element |

| | |
|---|---|
| 24. | </DataOut> |

| | |
|---|---|
| 25. | </Step> |
| 26. | . . . |

| | |
|---|---|
| 27. | </Steps> |

| | |
|---|---|
| 28. | </WorkflowPlan> |

Table 5 illustrates a schema of a workflow task in one embodiment. As indicated by lines 1 and 47, the workflow task includes a workflow task element. The workflow task element includes a data element (lines 2-12), a steps element (lines 13-31), and a step results element (lines 32-46). The data element includes a context element, a global element, and a next step element. These elements contain initial data generated by the data initialization rule of the workflow plan. The next step element (line 30) of the steps element indicates the next step that is to be performed during execution of the workflow task. The steps element (as defined above) may be copied directly from the workflow plan. In one embodiment, the workflow task includes a step results element. The step results element contains a step element for each step performed during execution of the workflow task. Each step element of the steps result element identifies the number of the step and the input data and output data of the step. The steps result element serves as an audit trail for the execution of the task. A workflow task thus has an initial state when it is first created, and its state is dynamically modified as the workflow task is executed.

TABEL 5
Workflow Task Schema

| | |
|---|---|
| 1. | <WorkflowTask> |

| | |
|---|---|
| 2. | <Data> |

| | |
|---|---|
| 3. | <Context> |

| | |
|---|---|
| 4. | elements |

| | |
|---|---|
| 5. | </Context> |
| 6. | <Global> |

| | |
|---|---|
| 7. | elements |

| | |
|---|---|
| 8. | </Global> |
| 9. | <NextStep> |

| | |
|---|---|
| 10. | elements |

| | |
|---|---|
| 11. | </NextStep> |

| | |
|---|---|
| 12. | </Data> |
| 13. | <Steps> |

| | |
|---|---|
| 14. | <Step> |

| | |
|---|---|
| 15. | <ProgID>progID</ProgID> |
| 16. | <SaveObjectID>objectID</SaveObjectID> |
| 17. | <ObjectID>objectID</ObjectID> |
| 18. | <Method>method</Method> |
| 19. | <DataIn copy-global=“value” |

| | |
|---|---|
| 20. | copy-nextstep=“value”> |

| | |
|---|---|
| 21. | element |

| | |
|---|---|
| 22. | </DataIn> |
| 23. | <DataOut> |

| | |
|---|---|
| 24. | <Global save-all=“value”> |
| 25. | <NextStep save-all=“value”> |
| 26. | element |

| | |
|---|---|
| 27. | </DataOut> |

| | |
|---|---|
| 28. | </Step> |
| 29. | . . . |

| | |
|---|---|
| 30. | <NextStep>value</NextStep> |

| | |
|---|---|
| 31. | </Steps> |
| 32. | <StepResults> |

| | |
|---|---|
| 33. | <Step> |

| | |
|---|---|
| 34. | <StepIndex>index</StepIndex> |
| 35. | <Data> |

| | |
|---|---|
| 36. | <DataIn> |

| | |
|---|---|
| 37. | elements |

| | |
|---|---|
| 38. | </DataIn> |
| 39. | <DataOut> |

| | |
|---|---|
| 40. | elements |

| | |
|---|---|
| 41. | </DataOut> |

| | |
|---|---|
| 42. | <Data> |
| 43. | <ErrorMsg>value</ErrorMsg> |

| | |
|---|---|
| 44. | </Step> |
| 45. | . . . |

| | |
|---|---|
| 46. | </StepResults> |

| | |
|---|---|
| 47. | </WorkflowTask> |

Tables 6-8 illustrates a sample workflow message, plan, and task in one embodiment. Table 6 illustrates a sample workflow message. In this example, the workflow message specifies that a workflow is to be created to fill an order as indicated by the plan identifier element of line 2. The order information is specified in the data element of lines 3-33. The data element indicates that the generated document type is a fill order document (line 5) and that the document is to be sent to “supplier1” (line 7). Line 6 indicates (i.e., “*”) that the source of the workflow message is irrelevant to how the message is processed. The message also defines connection information used by the components of the workflow task to retrieve the order information. In this example, the data for the order is specified in a file name as indicated by line 14.

TABLE 6
Workflow Message Sample

| | |
|---|---|
| 1. | <Create Workflow> |

| | |
|---|---|
| 2. | <PlanID>FulfillOrder Batch</PlanID> |
| 3. | <Data> |

| | |
|---|---|
| 4. | <Context xmlns:wrk=“urn:infinitestores.com:workflow”> |

| | |
|---|---|
| 5. | <DocType>FulfillOrder</DocType> |
| 6. | <SourceID>*</SourceID> |
| 7. | <DestID>Supplier1</DestID> |
| 8. | <Connection> |

| | |
|---|---|
| 9. | <ID>4</ID> |
| 10. | <Direction>2</Direction> |
| 11. | <Data> |

| | |
|---|---|
| 12. | <ConnectionFile> |

| | |
|---|---|
| 13. | <FileName> |

| | |
|---|---|
| 14. | <Text>test</Text> |
| 15. | <Date>MMDDHHMM</Date> |
| 16. | <Text>.850</Text> |

| | |
|---|---|
| 17. | </FileName> |
| 18. | <RemotePath>850</RemotePath> |

| | |
|---|---|
| 19. | </ConnectionFile> |
| 20. | <Live> |

| | |
|---|---|
| 21. | <ConnectionFile> |

| | |
|---|---|
| 22. | <FileName> |
| 23. | <Text>cwkshp</Text> |
| 24. | <Date>MMDDHHMM</Date> |
| 25. | <Text>.850</Text> |
| 26. | </FileName> |
| 27. | <RemotePath>850</RemotePath> |

| | |
|---|---|
| 28. | </ConnectionFile> |

| | |
|---|---|
| 29. | </Live> |

| | |
|---|---|
| 30. | </Data> |

| | |
|---|---|
| 31. | </Connection> |

| | |
|---|---|
| 32. | </Context> |

| | |
|---|---|
| 33. | </Data> |

| | |
|---|---|
| 34. | </CreateWorkflow> |

Table 7 illustrates a sample workflow plan for a fill order. The initialize data element of lines 2-6 defines the data initialization rule for the workflow task. Line 4 specifies an XSL transform that retrieves connection data from the workflow message. Lines 7-33 define the steps of the workflow plan. Lines 8-18 define the first step of the workflow plan. Line 9 identifies the component, line 10 indicates the name under which the instantiated component is to be saved, and line 11 indicates the method of the component to be invoked. Line 13 identifies the XSL transform of the data input rule. This XSL transform indicates to retrieve the connection identifier information from the global data. Lines 15-17 specify the data output rule. Line 16 specifies to save the global element of the output data into the global data. Lines 26-32 define the third step of the workflow plan. Line 26 illustrates a select condition that indicates whether the third step should be performed to during execution of the workflow task. In this example, the third step should only be performed when a “DocsProcessed” element of the global data has a value that is greater than 0 (e.g., if a fulfill order was successfully created). Line 27 of the third step also indicates that the component to be executed is the connection object that was instantiated and named in the first step.

TABLE 7
Workflow Plan Sample

| | |
|---|---|
| 1. | <WorkflowPlan name=“Fulfill Order Batch”> |

| | |
|---|---|
| 2. | <InitData> |

| | |
|---|---|
| 3. | <Global> |

| | |
|---|---|
| 4. | <ConnectionID><xsl:value-of |

select=“Connection”/></ConnectionID>

| | |
|---|---|
| 5. | </Global> |

| | |
|---|---|
| 6. | </InitData> |
| 7. | <Steps> |

| | |
|---|---|
| 8. | <Step> |

| | |
|---|---|
| 9. | <ProgID>MessageUtils.Connection</ProgID> |
| 10. | <SaveObjectID>Connection</SaveObjectID> |
| 11. | <Method>Open</Method> |
| 12. | <DataIn> |

| | |
|---|---|
| 13. | <ConnectionID><xsl:value-of |

select=“Global/ConnectionID ”/></ConnectionID>

| | |
|---|---|
| 14. | </DataIn> |
| 15. | <DataOut> |

| | |
|---|---|
| 16. | <Global save-all=“1”/> |

| | |
|---|---|
| 17. | </DataOut> |

| | |
|---|---|
| 18. | </Step> |
| 19. | <Step> |

| | |
|---|---|
| 20. | <ProgID>MessageUtils.BatchCombine</ProgID> |
| 21. | <DataIn copy-global=“1”/> |
| 22. | <DataOut> |

| | |
|---|---|
| 23. | <Global save-all=“1”/> |

| | |
|---|---|
| 24. | </DataOut> |

| | |
|---|---|
| 25. | </Step> |
| 26. | <Step select=“Global/DocsProcessed[.$gt$ 0]”> |

| | |
|---|---|
| 27. | <ObjectID>Connection</ObjectID> |
| 28. | <Method>Send</Method> |
| 29. | <DataIn> |

| | |
|---|---|
| 30. | <DocumentIO><xsl:value-of |

select=“Global/DocumentIO”/></DocumentIO>

| | |
|---|---|
| 31. | </DataIn> |

| | |
|---|---|
| 32. | </Step> |

| | |
|---|---|
| 33. | </Steps> |

| | |
|---|---|
| 34. | </WorkflowPlan> |

Table 8 illustrates a sample workflow task after execution of the workflow task. As indicated by lines 3-32, the context data of the data element contains information retrieved from the workflow message along with the task identifier of line 31. The task identifier uniquely identifies the workflow task. As indicated by lines 33-37, the global element contains various elements stored as the steps are performed. In this example, there is no next step data as indicated by line 38. As indicated by lines 40-71, the steps element contains a definition of each step along with an indication of the next step that used to track the next step to perform during execution of the workflow task. As indicated by line 72-112, the step results element has a step element for each step performed along with the input and output data of that step.

TABLE 8
Workflow Task Sample

| | |
|---|---|
| 1. | <WorkflowTask name=“FulfillOrder Batch” |
| | xmlns:xsl=“http://www.w3 org/TR/WD-xsl”xmlns:dt=“urn: |
| | shcemas-micrsoft-com:datatypes”> |

| | |
|---|---|
| 2. | <Data> |

| | |
|---|---|
| 3. | <Context xmlns:wrk=“urn:infinitestores.Com: |

Workflow”>

| | |
|---|---|
| 4. | <DocType>FulfillOrder</DocType> |
| 5. | <SourceID>*</SourceID> |
| 6. | <DestID>SynnexHP</DestID> |
| 7. | <Connection> |

| | |
|---|---|
| 8. | <ID>4</ID> |
| 9. | <Direction>2</Direction> |
| 10. | <Data> |

| | |
|---|---|
| 11. | <ConnectionFile> |

| | |
|---|---|
| 12. | <FileName> |

| | |
|---|---|
| 13. | <Text>test</Text> |
| 14. | <Date>MMDDHHMM</Date> |
| 15. | <Text>.850</Text> |

| | |
|---|---|
| 16. | </FileName> |
| 17. | <RemotePath>850</RemotePath> |

| | |
|---|---|
| 18. | </ConnectionFile> |
| 19. | <Live> |

| | |
|---|---|
| 20. | <ConnectionFile> |

| | |
|---|---|
| 21. | <FileName> |

| | |
|---|---|
| 22. | <Text>cwkshp</Text> |
| 23. | <Date>MMDDHHMM</ |

Date>

| | |
|---|---|
| 24. | <Text>.850</Text> |

| | |
|---|---|
| 25. | </FileName> |
| 26. | <RemotePath>850</ |

RemotePath>

| | |
|---|---|
| 27. | </ConnectionFile> |

| | |
|---|---|
| 28. | </Live> |

| | |
|---|---|
| 29. | </Data> |

| | |
|---|---|
| 30. | </Connection> |
| 31. | <TaskID |

>8A8FACDD21473C92E034080020B80609</TaskID>

| | |
|---|---|
| 32. | </Context> |
| 33. | <Global> |

| | |
|---|---|
| 34. | <ConnectionID/> |
| 35. | <DocumentIO>10FB43D9-A44B-49C8-8AFD- |

0A8B52D7796F</DocumentIO>

| | |
|---|---|
| 36. | <DocsProcessed>1</DocsProcessed> |

| | |
|---|---|
| 37. | </Global> |
| 38. | <NextStep/> |

| | |
|---|---|
| 39. | </Data> |
| 40. | <Steps> |

| | |
|---|---|
| 41. | <Step> |

| | |
|---|---|
| 42. | <ProgID>MessageUtils.Connection</ProgID> |
| 43. | <SaveObjectID>Connection</SaveObjectID> |
| 44. | <Method>Open</Method> |
| 45. | <DataIn> |

| | |
|---|---|
| 46. | <ConnectionID> |

| | |
|---|---|
| 47. | <xsl:value-of select=“Global/ |

ConnectionID”/>

| | |
|---|---|
| 48. | </ConnectionID> |

| | |
|---|---|
| 49. | </DataIn> |
| 50. | <DataOut> |

| | |
|---|---|
| 51. | <Global save-all=“1”/> |

| | |
|---|---|
| 52. | </DataOut> |

| | |
|---|---|
| 53. | </Step> |
| 54. | <Step> |

| | |
|---|---|
| 55. | <ProgID>MessageUtils.BatchCombine</ProgID> |
| 56. | <DataIn copy-global=“1”/> |
| 57. | <DataOut> |

| | |
|---|---|
| 58. | <Global save-all=“1”/> |

| | |
|---|---|
| 59. | </DataOut> |

| | |
|---|---|
| 60. | </Step> |
| 61. | <Step select=“Global/DocsProcessed[.$gt$ 0]”> |

| | |
|---|---|
| 62. | <ObjectID>Connection</ObjectID> |
| 63. | <Method>Send</Method> |
| 64. | <DataIn> |

| | |
|---|---|
| 65. | <DocumentIO> |

| | |
|---|---|
| 66. | <xsl:value-of select=“Global/ |

DocumentIO”/>

| | |
|---|---|
| 67. | </DocumentIO> |

| | |
|---|---|
| 68. | </DataIn> |

| | |
|---|---|
| 69. | </Step> |
| 70. | <NextStep>3</NextStep> |

| | |
|---|---|
| 71. | </Steps> |
| 72. | <StepResults> |

| | |
|---|---|
| 73. | <Step> |

| | |
|---|---|
| 74. | <StepIndex>0</StepIndex> |
| 75. | <Data> |

| | |
|---|---|
| 76. | <DataIn> |

| | |
|---|---|
| 77. | <ConnectionID/> |

| | |
|---|---|
| 78. | </DataIn> |
| 79. | <DataOut> |

| | |
|---|---|
| 80. | <DocumentIO>10FB43D9-A44B-49C8- |

8AFD-0A8B52D7796F</DocumentIO>

| | |
|---|---|
| 81. | </DataOut> |

| | |
|---|---|
| 82. | </Data> |
| 83. | <ErrorMsg/> |

| | |
|---|---|
| 84. | </Step> |
| 85. | <Step> |

| | |
|---|---|
| 86. | <StepIndex>1</StepIndex> |
| 87. | <Data> |

| | |
|---|---|
| 88. | <DataIn copy-global=“1”> |

| | |
|---|---|
| 89. | <ConnectionID/> |
| 90. | <DocumentIO>10FB43D9-A44B-49C8- |

8AFD-0A8B52D7796F</DocumentIO>

| | |
|---|---|
| 91. | </DataIn> |
| 92. | <DataOut> |

| | |
|---|---|
| 93. | <DocsProcessed>1</DocsProcessed> |

| | |
|---|---|
| 94. | </DataOut> |

| | |
|---|---|
| 95. | </Data> |
| 96. | <ErrorMsg/> |

| | |
|---|---|
| 97. | </Step> |
| 98. | <Step> |

| | |
|---|---|
| 99. | <StepIndex>2</StepIndex> |
| 100. | <Data> |

| | |
|---|---|
| 101. | <DataIn> |

| | |
|---|---|
| 102. | <DocumentIO>10FB43D9-A44B-49C8- |

8AFD-0A8B52D7796F</DocumentIO>

| | |
|---|---|
| 103. | </DataIn> |
| 104. | <DataOut> |

| | |
|---|---|
| 105. | <FtpResults> |

| | |
|---|---|
| 106. | <Sent>True</Sent> |

| | |
|---|---|
| 107. | </FtpResults> |

| | |
|---|---|
| 108. | </DataOut> |

| | |
|---|---|
| 109. | </Data> |
| 110. | <ErrorMsg/> |

| | |
|---|---|
| 111. | </Step> |

| | |
|---|---|
| 112. | </StepResults> |

| | |
|---|---|
| 113. | </WorkflowTask> |

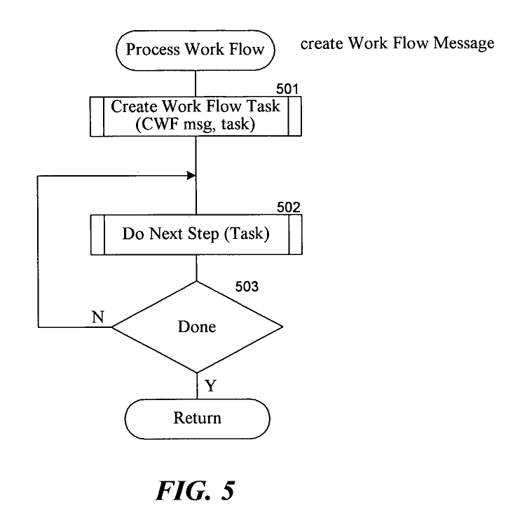

FIGS. 5-17 are flow diagrams illustrating processing of the workflow manager in one embodiment. FIG. 5 is a flow diagram illustrating processing of the process workflow function in one embodiment. This function is passed a workflow message, creates a workflow task, and executes that workflow task. In block 501, the function invokes the create workflow task function passing the workflow message. The invoked function creates and returns a workflow task for the passed workflow message. In blocks 502-503, the function loops performing each step of the workflow task. In block 502, the function invokes the do next step function passing the created task. The invoked function performs the step indicated by the next step element of task and increments the next step element. In decision block 503, if all the steps of the task have already been performed, then the function completes, else the function continues at block 502 to perform the next step of the task.

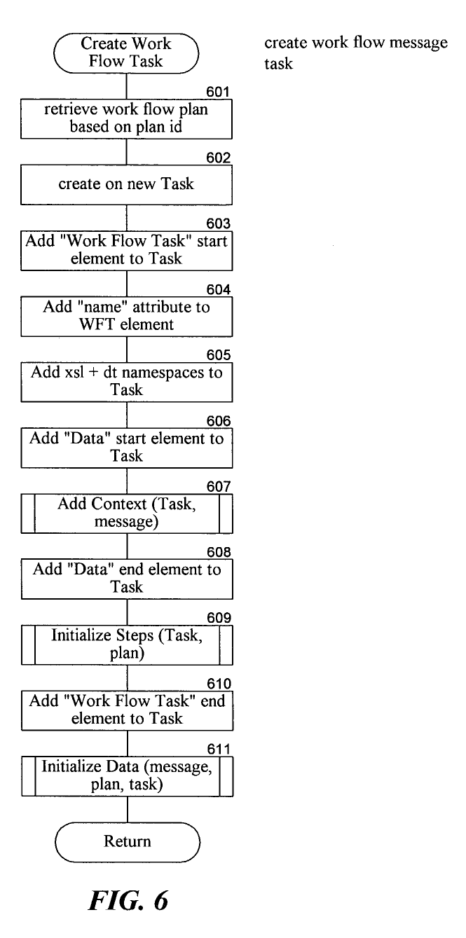

FIG. 6 is a flow diagram illustrating processing of the create workflow task function in one embodiment. This function is passed a workflow message and returns the corresponding workflow task. In block 601, the function retrieves the workflow plan based on the plan identifier of the workflow message. In block 602, the function creates a new base workflow task. In block 603, the function adds a start workflow task tag to the workflow task. In block 604, the function adds a name attribute to the workflow task element. The name attribute has the value of the name attribute of the workflow plan element of the workflow plan. In block 605, the function adds XSL and data type namespace attributes to the workflow task. In block 606, the function adds the start data tag to the workflow task. In block 607, the function invokes the add context function passing the workflow task and the message to add the context data from the message to the workflow task. In block 608, the function adds the end data tag to the workflow task. In block 609, the function invokes the initialize step function passing the workflow task and the workflow plan to add the steps to the workflow task. The function then adds the step results element to the workflow task. In block 610, the function adds the end workflow task tag to the task. In block 611, the function invokes the initialize data function passing the message, the workflow plan, and the workflow task. The invoked function initializes the global and next step data of the workflow task. The function then returns the workflow task.

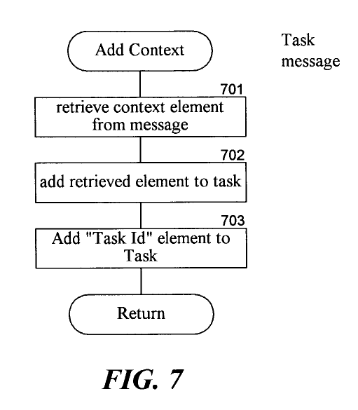

FIG. 7 is a flow diagram illustrating processing of the add context function in one embodiment. The function is passed the workflow task and the workflow message. The function copies the context data from the workflow message to the workflow task. In block 701, the function retrieves the context element from the workflow message. In block 702, the function adds the retrieved element to the workflow task. In block 703, the function adds a task identifier element to the workflow task. The task identifier element may include a message identifier that uniquely identifies the workflow message. The function then returns.

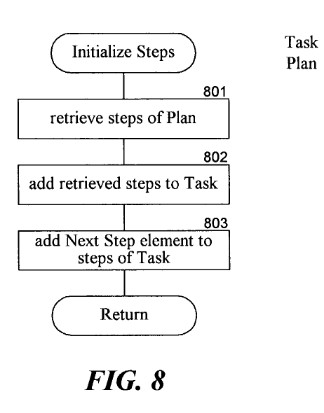

FIG. 8 is a flow diagram illustrating processing of the initialize steps function in one embodiment. The function is passed the workflow task and the workflow plan. The function adds the steps of the workflow plan to the workflow task. In block 801, the function retrieves the step elements of the workflow plan. In block 802, the function adds the retrieved step elements to the workflow task. In block 803, the function adds the next step element to the steps element (indicating the first step) to the workflow task. The function then returns.

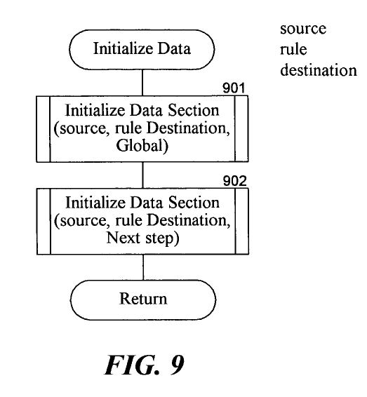

FIG. 9 is a flow diagram illustrating processing of the initialize data function in one embodiment. The function is passed a source (e.g., workflow message), a data initialization rule (e.g., workflow plan), and a destination (e.g., workflow task). The function applies the data initialization rule to the source to generate data for the destination for both global and next step elements of the destination. In block 901, the function invokes the initialize data section function passing the source, the data input rule, the destination, and an indication of the global element. In block 902, the function invokes the initialize data section function passing the source, the data input rule, the destination, and an indication of the next step element. The function then returns.

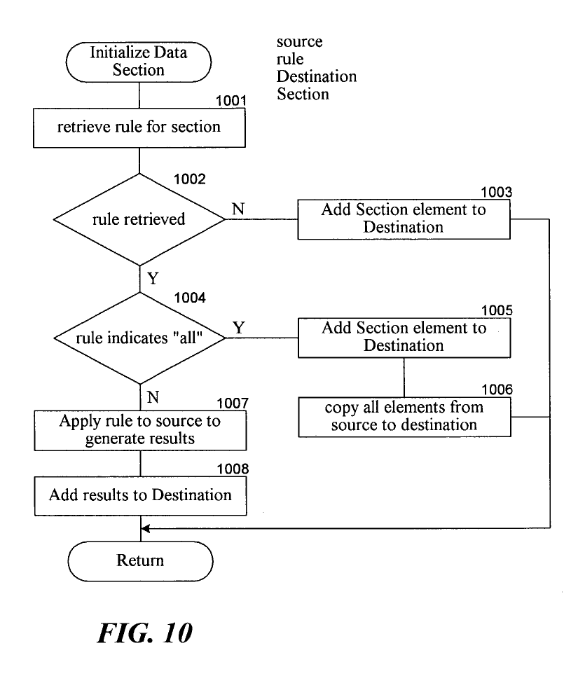

FIG. 10 is a flow diagram illustrating processing of the initialize data section function in one embodiment. The function is passed a source, a rule, a destination, and a section indication. The function processes the rule against the source and stores the results in the indicated section of the destination. In block 1001, the function retrieves the rule for the section from the passed rule. In decision block 1002, if the rule is retrieved, then the function continues at block 1004, else the function continues at block 1003. In block 1003, the function adds the section element to the destination to indicate an empty section and then returns. In decision block 1004, if the rule indicates to copy all the elements of the source, then the function continues at block 1005, else the function continues at block 1007. In block 1005, the function adds the section element to the destination. In block 1006, the function copies all elements of the source to the destination and then returns. In block 1007, the function applies the XSL transform of the rule to the source to generate results. In block 1008, the function adds the results to the destination in a section element and then returns.

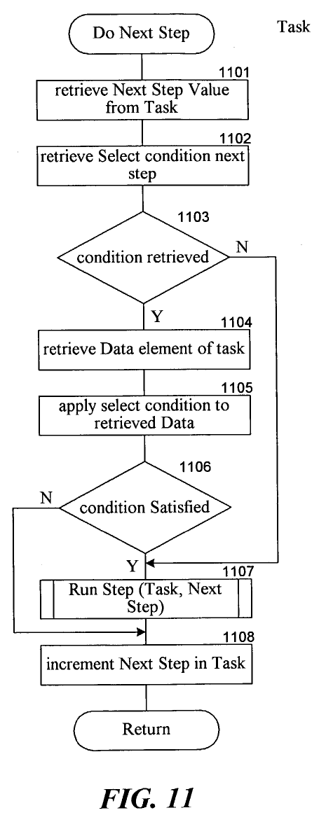

FIG. 11 is a flow diagram illustrating processing of the do next step function in one embodiment. The function is passed a workflow task. The function performs the next step of the workflow task indicated by the next step element of the workflow task. In block 1101, the function retrieves the next step element from the workflow task. In block 1102, the function retrieves the condition of the select attribute of the next step to be performed. In decision block 1103, if the select condition is retrieved, then the function continues at block 1104 to determine whether the condition is satisfied, else the function performs the next step by continuing at block 1107. In block 1104, the function retrieves the data element of the workflow task. In block 1105, the function applies the condition to the retrieved data. In decision block 1106, if the condition is satisfied, then the function performs the step by continuing at block 1107, else then the function skips the step by continuing at block 1108. In block 1107, the function invokes the run step function passing the workflow task and an indication of the next step. In block 1108, the function increments the next step element of the workflow task and then returns.

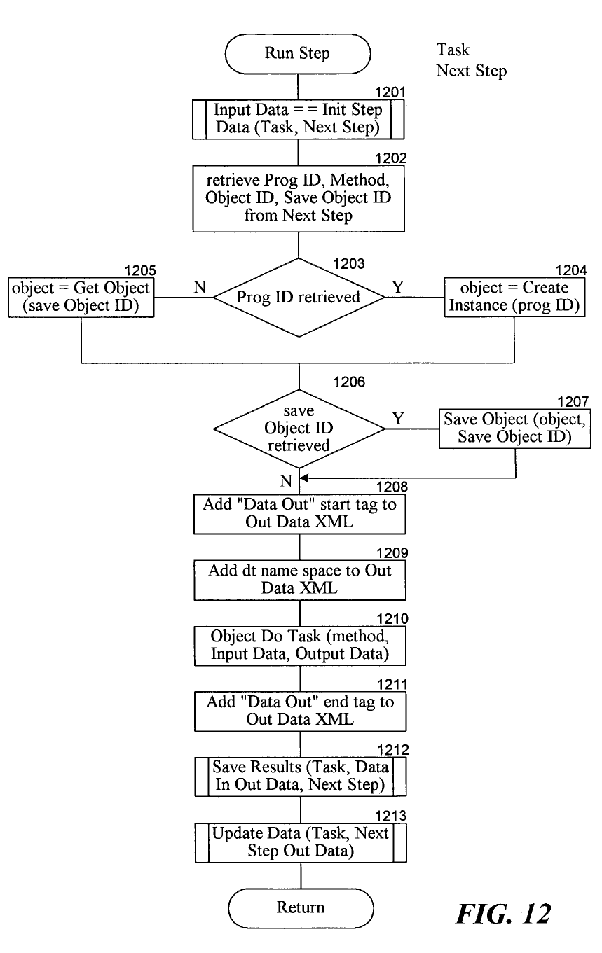

FIG. 12 is a flow diagram illustrating processing of the run step function in one embodiment. The function is passed the workflow task and an indication of the next step to be performed. The function performs the indicated next step of the workflow task. In block 1201, the function invokes the initialize step data function passing the workflow task and an indication of the next step. The invoked function returns the input data (e.g., as an XML document) for the component. In block 1202, the function retrieves the program identifier, method identifier, object identifier, or saved object identifier from the next step. In decision block 1203, if the program identifier was retrieved, then the function continues at block 1204, else the function continues at block 1205. In block 1204, the function creates an instance (e.g., object) of the component identified by the program identifier. In block 1205, the function retrieves a previously instantiated object as indicated by the saved object identifier. In decision block 1206, if the saved object identifier was retrieved, then the function continues at block 1207, else the function continues at block 1208. In block 1207, the function saves the object in association with the saved object identifier for use by a subsequent step of the task. In block 1208, the function adds a start data out tag to the output data. In block 1209, the function adds a data type namespace attribute to the output data. In block 1210, the function invokes the component passing the method identifier and the input data, and receives the output data in return. In block 1211, the function adds an end data out tag to the output data. In block 1212, the function invokes the save results function passing the workflow task, the output data, the input data, and an indication of the next step. The invoked function adds a step element to the step results on the workflow task. In block 1213, the function invokes the update data function passing the workflow task, indication of the next step, and the output data. The update data function updates the data element of the workflow task in accordance with the data output rule and output data of the step. The function then returns.

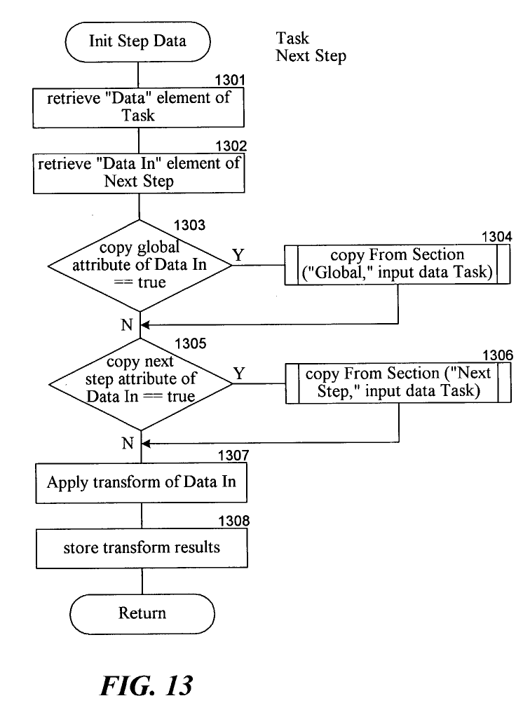

FIG. 13 is a flow diagram illustrating processing of the initialize step data function in one embodiment. The function is passed the workflow task and an indication of the next step. The function initializes and returns the input data for the step to be performed. In block 1301, the function retrieves the data element of the workflow task. In block 1302, the function retrieves the data in element of the next step, which defines the data input rule. In decision block 1303, if the copy global attribute of the data in element is present, then the function continues at block 1304, else the function continues at block 1305. In block 1304, the function invokes the copy from selection function passing an indication of the global section, input data, and the workflow task. The invoked function copies the global data to the input data. In decision block 1305, if the copy next step attribute of the data in element is present, then the function continues at block 1306, else the function continues at block 1307. In block 1306, the function invokes the copy from selection function passing an indication of the next step section, input data, and the workflow task. The invoked function copies the next step data to the input data. In block 1307, the function applies the XSL transform to generate results. In block 1308, the function stores the generated result in the input data. The function then returns the input data.

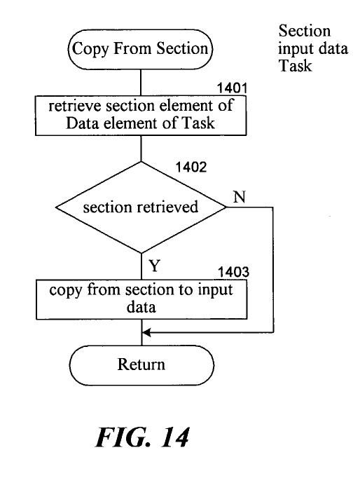

FIG. 14 is a flow diagram illustrating processing of the copy from selection function in one embodiment. This function is passed an indication of the section, input data, and the workflow task. The function copies data from the section to the input data. In block 1401, the function retrieves the section element of the data element of the workflow task. In decision block 1402, if the section element was retrieved, then the function continues at block 1403, else the function returns. In block 1403, the function copies the section data to the input data and then returns.

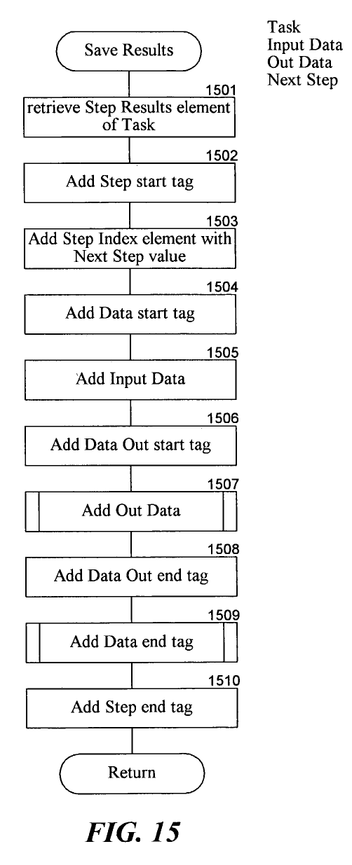

FIG. 15 is a flow diagram illustrating processing of the save results function in one embodiment. The function is passed an indication of the workflow task, the input data, the output data, and an indication of the next step. The function saves results in the step results element of the workflow task. In block 1501, the function retrieves the step results element of the workflow task. In block 1502, the function adds a start step tag to the retrieved step results element. In block 1503, the function adds a step index element indicating the step whose results are stored. In block 1504, the function adds a start data tag. In block 1505, the function copies the input data element. In one embodiment, the input data includes a data in element. In block 1506, the function adds a start data out tag. In block 1507, the function adds the output data. In block 1508, the function adds the end data out tag. In block 1509, the function adds the end data tag. In block 1510, the function adds the end step tag and then returns.

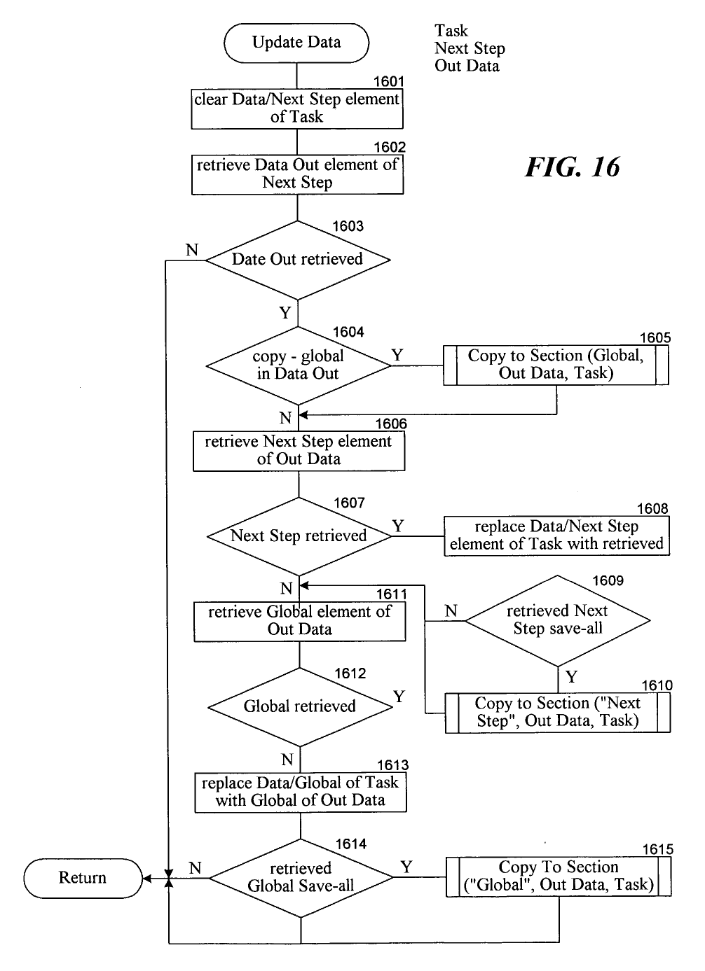

FIG. 16 is a flow diagram illustrating processing of the update data function in one embodiment. The function is passed the workflow task, an indication of the next step, and the output data. The function updates the data section of the workflow task. In block 1601, the function clears the next step data of the workflow task. In block 1602, the function retrieves the data output rule of the next step. In decision block 1603, if the data output rule is retrieved, then the function applies the rule to transform the output data and continues at block 1604, else the function returns. In decision block 1604, if the data output rule indicates to copy global, then the function continues at block 1605, else the function continues at block 1606. In block 1605, the function invokes the copy to section function passing an indication of the global section, the output data, and the workflow task. In block 1606, the function retrieves the next step element of the transformed output data. In decision block 1607, if the next step element was retrieved, then the function continues at block 1608, else the function continues at block 1611. In block 1608, the function replaces the next step element of the workflow task with the retrieved next step element of the transformed output data. In decision block 1609, if the retrieved next step element indicates to save all, then the function continues at block 1610, else the function continues at block 1611. In block 1610, the function invokes the copy to section function passing an indication of the next step section, the output data, and the workflow task. In block 1611, the function retrieves the global element of the transformed output data. In decision block 1612, if the global element was retrieved, the function continues at block 1613, else the function returns. In block 1613, the function replaces the global element of the workflow task data with the global data of the transformed output data. In decision block 1614, if the retrieved global element indicates to save all, then the function continues at block 1615, else the function returns. In block 1650 function invokes the copy to section function passing an indication of the global section, the output data, and the workflow task. The function then returns.

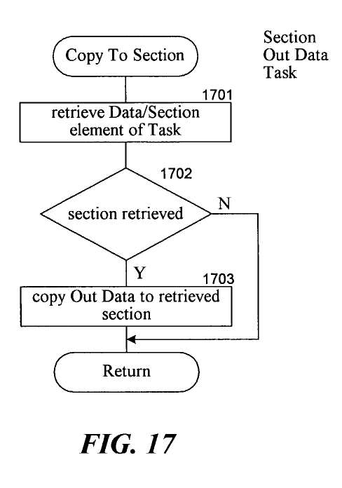

FIG. 17 is a flow diagram illustrating processing of the copy to selection function in one embodiment. The function is passed an indication of a data section, the output data, and the workflow task. The function copies the output data to the section. In block 1701, the function retrieves the section element from the workflow task. In decision block 1703, the section element was retrieved, then the function continues at block 1703, else the function returns. In block 1703, the function copies the section of the output data to the retrieved section and then returns.

From the above description, it will be appreciated that although specific embodiments of the workflow system have been described for purposes of illustration, various modifications may be made without deviating from the scope of the invention. Accordingly, the invention is not limited except by the following claims.

1. A method in a computer system for reusing components, the method comprising:
providing a plurality of components;
providing definitions of a plurality of workflow tasks, each definition identifying one or more of the plurality of components and optionally identifying for each identified component an data input rule and a data output rule, wherein the same component is identified in at least two definitions; and
executing the workflow tasks defined by the provided definitions by, for each component of a workflow task,
when a data input rule is identified for the component, applying the identified data input rule to data for the workflow to generate input data;
executing the component, wherein the component generates output data based on any generated input data; and
when a data output rule is identified for the component, applying the data output rule for the component to the generated output data to update data for the workflow
wherein multiple workflow tasks reuse the same component.

2. The method of claim 1 including providing initial data for a workflow task.

3. The method of claim 1 wherein providing a definition of workflow task includes:
receiving a workflow message identifying a type of workflow and identifying initial data for the workflow task;
retrieving a workflow plan for the identified type of workflow; and
creating a definition a workflow task based on the identified initial data of the workflow message and the retrieved workflow plan.

4. The method of claim 3 wherein the workflow task includes context data derived from the received workflow message.

5. The method of claim 1 wherein a definition of a workflow task is an XML document.

6. The method of claim 1 wherein the data input rule and the data output rule specify an XSL transform.

7. The method of claim 1 including persistently storing the input data and output data for each component.

8. The method of claim 1 wherein the data for a workflow task is divided into data that is global to all components of the workflow task and data that is specific to the next component of the workflow task to be executed.

9. The method of claim 1 wherein a component of a workflow task is instantiated once and executed multiple times during execution of the workflow task.

10. A method in a computer system for instantiating a workflow task, the method comprising:
providing a plurality of workflow plans, each workflow plan having a type and one or more steps, each step identifying a component and optionally identifying a data input rule and a data output rule;
receiving a workflow message identifying a type of workflow and identify initial data for the workflow task;
retrieving a workflow plan for the identified type of workflow; and
generating a workflow task based on the identified initial data of the workflow message and the retrieved workflow plan, the workflow task indicating the steps of the workflow plan.

11. The method of claim 10 wherein a workflow plan includes a data initialization rule for initializing data of the workflow task based on the identified initial data of received workflow message.

12. The method of claim 10 wherein a step of the workflow task identifies a method of the component that is to be invoked when the component is executed.

13. The method of claim 10 including performing the steps of the workflow task including applying the data input rule for the component to data for the workflow to generate input data, executing the component passing the input data, wherein the component generates output data, and applying the data output rule for the component to the generated output data to update data for the workflow.

14. The method of claim 10 wherein a step includes a select condition that indicates whether the step should be performed based on data of the workflow task.

15. The method of claim 10 wherein the workflow message, workflow plan, workflow task, input data, and output data are in XML format.

16. A computer-readable medium containing a workflow plan comprising:
a data initialization rule; and
a plurality of steps, each step identifying a component, a data input rule, and a data output rule, the data input rule and the data output rule indicating how to generate input data for the component and how to update data of a workflow task based on output data of the component.

17. The computer-readable medium of claim 16 wherein the workflow plan is an XML document.

18. The computer-readable medium of claim 16 wherein the data input rule and the data output rule include an XSL transform.

19. The computer-readable medium of claim 16 wherein the data input rule includes a data name and data value to be passed to the component.

20. The computer-readable medium of claim 16 wherein the data initialization rule specifies to retrieve initialization data from a workflow message.

21. The computer-readable medium of claim 16 wherein a step of the workflow plan identifies a method of the component that is to be invoked when the component is executed.

22. The computer-readable medium of claim 16 wherein a step includes a select condition that indicates whether the step should be performed based on data of a workflow task.

23. A method in a computer system for executing a workflow task that reuses a component used by another workflow task, the method comprising:
for a plurality of components of the workflow task,
transforming data of the workflow task to generate input data in a format that is expected by the component;
executing the component to generate output data from the generated input data; and
transforming the generated output data into data in a format that is expected by the workflow task
wherein each workflow tasks that uses the component uses customized transformations for generating the input data and the output data so that the component can be shared by multiple workflow tasks.

24. The method of claim 23 wherein a workflow task is defined in an XML document.

25. The method of claim 24 wherein the customized transformations are XSL transforms.

26. The method of claim 23 wherein a workflow task includes an identifier of a data input rule for a component, wherein the data input rule is applied to transform the data of the workflow task to generate the input data.

27. The method of claim 23 wherein a workflow task includes an identifier of an data output rule for a component, wherein the data output rule is applied to transform the generated output data to data of the workflow task.

28. The method of claim 23 wherein a workflow task is defined by an XML document and the transformations are specified by an XSL transform.

29. The method of claim 23 wherein the workflow task has a plurality of steps that each specify a component and optionally specify a data input rule and an data output rule.
